(19) United States
(12) Patent Application Publication
(10) Pub. No.: US 2015/0243057 A1
(43) Pub. Date: Aug. 27, 2015

(54) METHODS OF RENDERING GRAPHICS BY STROKING PATHS

(71) Applicant: Nvidia Corporation, Santa Clara, CA (US)

(72) Inventor: Samuel Gateau, San Francisco, CA (US)

(21) Appl. No.: 14/625,885

(22) Filed: Feb. 19, 2015

Related U.S. Application Data
(60) Provisional application No. 61/943,337, filed on Feb. 22, 2014.

(51) Int. Cl. G06T 11/20

(52) U.S. Cl. CPC G06T 11/20

(57) ABSTRACT

Methods of rendering graphics include defining one or more paths from a plurality of commands. The commands include corresponding coordinates and pen actions, and the commands generate sub-paths or curve segments. The methods include applying geometric transformations to map the paths from an object space to a render surface. The methods include binding the paths to a path input stage, and stroking the paths bound to the path input stage based on a stroke style. The stroke style includes stroke parameters, stroke state and dash patterns. The stroke parameters include stroke width, color, and pattern scale.

### CROSS REFERENCE TO RELATED APPLICATION

This application relates to and claims priority from U.S. Provisional Patent Application No. 61/943,337, entitled “AN EFFICIENT ALGORITHM FOR PATH RENDERING STROKING AND FILING TAKING ADVANTAGE OF THE GPU”, by Samuel Gateau, filed Feb. 22, 2014, and incorporated herein by reference.

### TECHNICAL FIELD

The present disclosure is directed, in general, to rendering graphics.

### BACKGROUND

Computer aided design (CAD) tools are utilized by architects, engineers and other designers for rendering graphics. Rendering is a process of generating graphics or images from a model using a CAD tool. Rendering enables visualization of a model by transforming the model (e.g., a two-dimensional model) to an image. Rendering has applications in the fields of video games, movies, architecture and engineering.

Generally, in a rendering process, a data file containing objects is generated and a rendering pipeline for a rendering device is formed. The rendering device may be a graphics processing unit (GPU) which is a special purpose processor able to assist a central processor unit (CPU) in performing complex rendering calculations.

### SUMMARY

In one aspect, a method of rendering graphics is disclosed. In one embodiment, the method includes: (1) defining one or more paths from a plurality of commands, (2) applying geometric transformations to map the paths from an object space to a render surface, (3) binding the paths to a path input stage and (4) stroking the paths bound to the path input stage based on a stroke style.

In another aspect, the disclosure provides a non-transitory computer-readable medium. In one embodiment, the non-transitory computer-readable medium is encoded with computer-executable instructions for rendering two-dimensional graphics, wherein the computer-executable instructions when executed cause at least one data processing system to: (1) define one or more paths from a plurality of commands, (2) apply geometric transformations to map the paths from the object space to a render surface, (3) bind the paths to a path input stage and (4) stroke the paths bound to the path input stage based on stroke style.

In yet another aspect, a graphics rendering system for rendering two-dimensional graphics is disclosed. In one embodiment, the graphics rendering system includes: (1) a graphics processing unit and (2) a memory coupled to the graphics processing unit, wherein the memory contains computer-executable instructions to cause the graphics processing unit to define one or more paths from a plurality of commands; apply geometric transformations to map the paths from the object space to a render surface; bind the paths to a path input stage; and stroke the paths bound to the path input stage based on stroke style.

### BRIEF DESCRIPTION

Reference is now made to the following descriptions taken in conjunction with the accompanying drawings, in which:

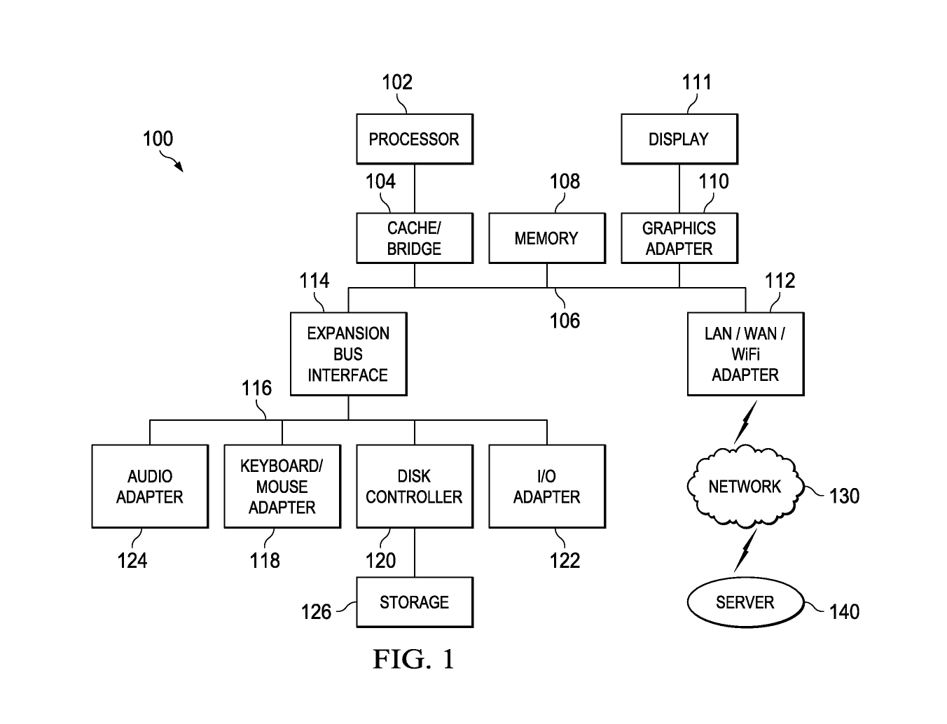

FIG. 1 illustrates a block diagram of a data processing system according to various disclosed embodiments;

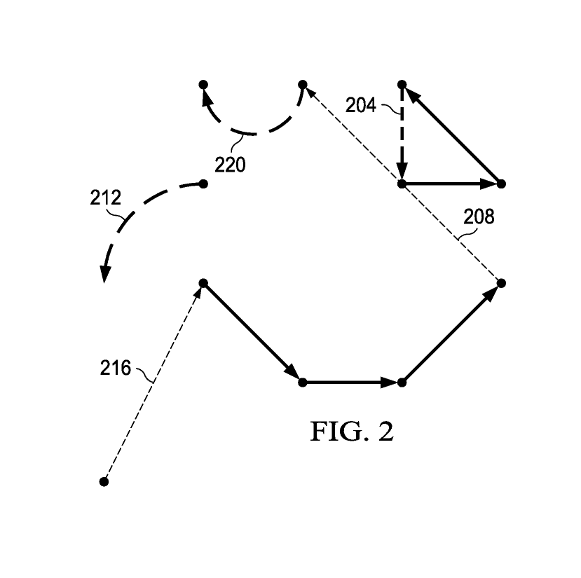

FIG. 2 illustrates an example of curve segments created by commands according to the principles of the disclosure;

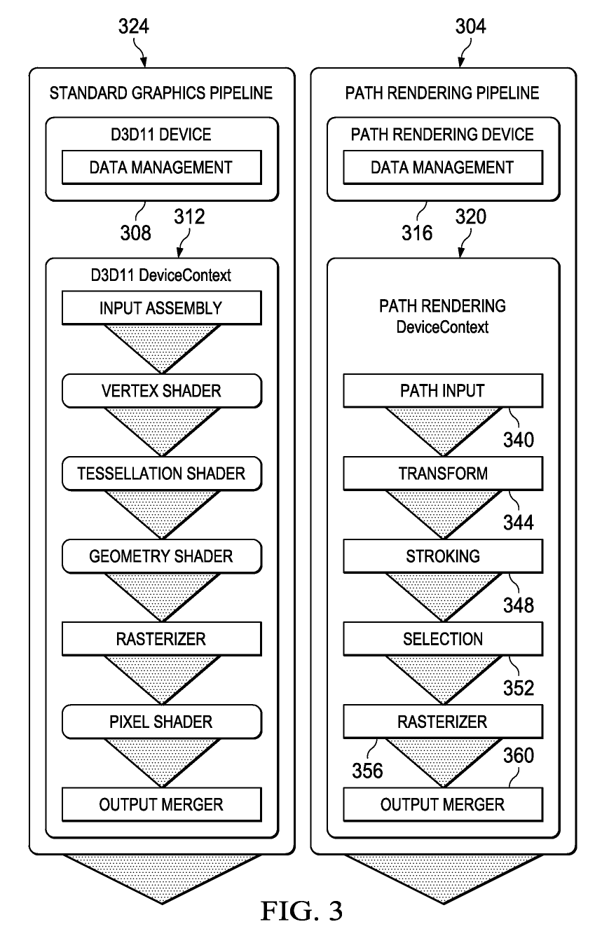

FIG. 3 illustrates an example of a path rendering pipeline;

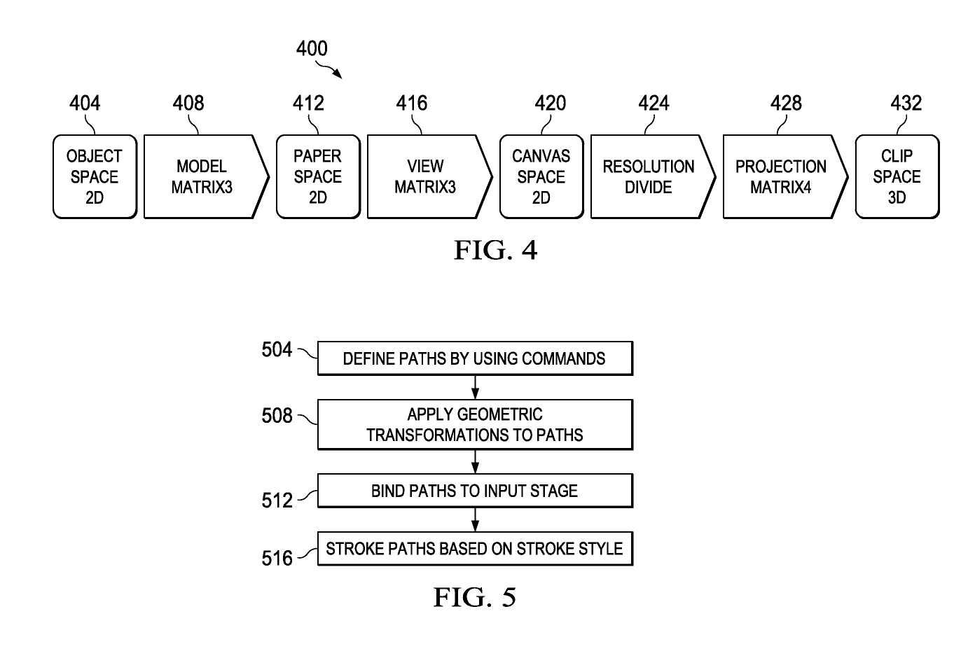

FIG. 4 generally illustrates a transform stack; and

FIG. 5 is a flowchart of a process carried out according to the principles of the disclosure.

### DETAILED DESCRIPTION

FIGS. 1-5, discussed below, and the various embodiments used to describe the principles of the present disclosure are by way of illustration only and do not in any way limit the scope of the disclosure. Those skilled in the art will recognize that the principles of the disclosure may be implemented in any suitably arranged device or system. The numerous innovative teachings of the present disclosure will be described with reference to non-limiting embodiments.

Various disclosed embodiments are directed to methods of rendering graphics by stroking paths. A path is a sequence of co-planar curves (e.g., straight line, circular arcs, quadratic arcs, cubic Bezier arcs) that define an intrinsic geometry of the path. The paths are created by one or more commands.

FIG. 1 depicts a block diagram of data processing system 100 in which an embodiment can be implemented, for example, as a system particularly configured by software, hardware or firmware to perform the processes as described herein, and in particular as each one of a plurality of interconnected and communicating systems as described herein. Data processing system 100 may be implemented for rendering two-dimensional graphics by stroking paths.

Referring to FIG. 1, the data processing system 100 depicted includes processor 102 connected to level two cache/bridge 104, which is connected in turn to local system bus 106. Local system bus 106 may be, for example, a peripheral component interconnect (PCI) architecture bus. Also connected to local system bus 106 in the depicted example are main memory 108 and graphics adapter 110, which may be connected to display 111. The processor 102 may include a central processing unit (CPU) and a graphics processing unit (GPU). The processor 102 can cooperate with the memory 108 to form a graphics rendering system. The graphics rendering system can include the GPU coupled to the memory 108, wherein the memory 108 includes computer-executable instructions to cause the GPU to define one or more paths from a plurality of commands, apply geometric transformations to map the paths from the object space to a render surface, bind the paths to a path input stage and stroke the paths bound to the path input stage based on stroke style.

In one embodiment, the graphics rendering system includes the memory 108 that is configured to store rendering instructions and the GPU that is configured to define one or more paths from a plurality of commands, apply geometric transformations to map the paths from the object space to a render surface, bind the paths to a path input stage and stroke the paths bound to the path input stage based on stroke style.

Other peripherals, such as local area network (LAN)/Wide Area Network/Wireless (e.g. WiFi) adapter 112, may also be connected to local system bus 106. Expansion bus interface 114 connects local system bus 106 to input/output (I/O) bus 116. I/O bus 116 is connected to keyboard/mouse adapter 118, disk controller 120, and I/O adapter 122. Disk controller 120 can be connected to storage 126, which can be any suitable non-transitory machine usable or machine readable storage medium, including but not limited to nonvolatile, hard-coded type mediums such as read only memories (ROMs) or erasable, electrically programmable read only memories (EEPROMs), magnetic tape storage, and user-recordable type mediums, such as floppy disks, hard disk drives and compact disk read only memories (CD-ROMs) or digital versatile disks (DVDs), and other known optical, electrical, or magnetic storage devices.

Also connected to I/O bus 116 in the example shown is audio adapter 124, to which speakers (not shown) may be connected for playing sounds. Keyboard/mouse adapter 118 provides a connection for a pointing device (not shown), such as a mouse, trackball, trackpointer, etc.

Those of ordinary skill in the art will appreciate that the hardware depicted in FIG. 1 may vary for particular implementations. For example, other peripheral devices, such as an optical disk drive and the like, also may be used in addition or in place of the hardware depicted. The depicted example is provided for the purpose of explanation only and is not meant to imply architectural limitations with respect to the present disclosure.

Data processing system 100 in accordance with an embodiment of the present disclosure includes an operating system employing a graphical user interface. The operating system permits multiple display windows to be presented in the graphical user interface simultaneously, with each display window providing an interface to a different application or to a different instance of the same application. A cursor in the graphical user interface may be manipulated by a user through the pointing device. The position of the cursor may be changed and/or an event, such as clicking a mouse button, generated to actuate a desired response.

LAN/WAN/Wireless adapter 112 can be connected to network 130 (not a part of data processing system 100), which can be any public or private data processing system network or combination of networks, as known to those of skill in the art, including the Internet. Data processing system 100 can communicate over network 130 with server system 140, which is also not part of data processing system 100, but can be implemented, for example, as a separate data processing system 100. Data processing system 100 may be configured as a workstation, and a plurality of similar workstations may be linked via a communication network to form a distributed system in accordance with embodiments of the disclosure.

According to disclosed embodiments, a method of rendering graphics includes defining one or more paths. A path is defined as a sequence of curve segments (e.g., straight lines, circular arcs, quadratic arcs and cubic Bezier arcs) which define the intrinsic geometry of the path. The path is a mathematical representation of curve segments in a two-dimensional space called an object space. The path is created from one or more commands. The commands and corresponding coordinates describe moves of a pen stroking the path on a paper.

According to some disclosed embodiments, the commands and corresponding coordinates of a path may be defined initially and not subsequently modified, thus creating a static path. If needed, the coordinates, but not the commands, may be updated dynamically. If the commands need to be modified, the path may be destructed and a new path may be created.

According to disclosed embodiments, a path may be formed by a plurality of curve segments. The curve segments are considered sub-paths of the path.

Table 1 below lists examples of commands, corresponding coordinates, pen actions and resulting curve segments or sub-paths.

TABLE I

| COMMAND | COORDINATES | PEN ACTION | SUB-PATHS |
|---|---|---|---|
| Move to | Float2 pos | Move pen to | Complete |
| | | specified | current sub- |
| | | position | path and begin |
| | | | new sub-path |
| Close | | Close current | Complete |
| | | sub-path by | current sub- |
| | | drawing | path and begin |
| | | straight line | new sub-path |
| | | from end to | |
| | | start position | |
| Line to | Float2 pos | Stroke line to | Append to |
| | | specified | current sub- |
| | | position | path |
| Circular arc to | Float2 center | Stroke | Append to |
| | Float radius | specified arc | current sub- |
| | Float begin | segment of | path |
| | angle | circle | |
| | Float end angle | | |

FIG. 2 illustrates an example of curve segments created by the commands of Table 1. The command “Move to” generates segment 204. The command “Close” generates segment 208. The command “Arc to” generates segment 212. The command “Line to” generates segment 216. The command “Arc to” generates segment 220.

According to disclosed embodiments, a list of curve segments of a path is generated for a path rendering pipeline. For example, a path rendering library may create a path rendering pipeline to a conventional pipeline such as, for example, a Direct3D11 pipeline.

FIG. 3 illustrates a path rendering pipeline 304 built according to disclosed embodiments. By way of example, the path rendering pipeline 304 may be built on a Direct3D11 pipeline using C++ for Microsoft Windows7. A D3D11Device 308 and D3D11DeviceContext 312 may be created by a user program. Next, corresponding D3D11 PathRenderingDevice (PathRenderingDevice) 316 and D3D11 PathRenderingDeviceContext (PRDeviceContext) 320, which are objects that form a companion path rendering pipeline for a standard D3D11 rendering pipeline 324, may be created.

The PathRenderingDevice 316 is responsible for creating and managing resources and state objects used for path rendering. The objects create their internal D3D11 objects on the referenced D3D11Device. The PRDeviceContext 320 is assigned a rendering state to configure the rendering pipeline and then drawing commands are issued. Other PRDeviceContexts can be created from the PathRenderingDevice 316 in order to generate path rendering commands from several threads.

According to disclosed embodiments, the path rendering pipeline 304 includes the following stages:

Path Input 340: The path input 340 is a binding point of the paths in use for rendering or selection.

Transform 344: The transform 344 includes matrix states for transforming the path from a local space to a final rendering surface.

Stroking 348: The stroking 348 configures the stroking style: stroke state, color, width and dash pattern.

Selection 352: The selection state 352 configures selection commands.

Rasterizer 356: The rasterizer 356 transforms the image into pixels.

Output Merger 360: A standard D3D11DepthStencilState and D3D11BlendState may be used to control the output merger 360 in the PRDeviceContext 320.

As discussed before, according to disclosed embodiments, geometric transformations are applied to map the paths from the object space to a render surface. FIG. 4 illustrates an example of a transform stack. The transform stack includes parameters that may be modified. The transform stack 400 can be employed in the transform stage 344 of FIG. 3.

As shown in FIG. 4, a two-dimensional object space 404 is transformed into a paper space 412 by a model matrix 408. The paper space 412 is then transformed into a canvas space 420 by a view matrix 416. Next, a resolution divide 424 and a projection matrix 428 are applied to the canvas space 420 to generate a three-dimensional clip space 432.

According to disclosed embodiments, one or more paths may be bound to a path input stage. Thereafter, the paths may be stroked using a stroking style. By way of example, the paths may be stroked by calling a stroke command on the Path Rendering Device Context 320 of FIG. 3. A plurality of bound paths can be stroked with the same stroking style using one command.

According to disclosed embodiments, a stroking style is configured from the following: stroke state; stroke parameters; and dash pattern. The stroking style describes the style applied to the paths. According to disclosed embodiments, a path can be applied any style configuration without requiring any regeneration or processing time.

According to disclosed embodiments, a stroking style may be applied to a path while rendering on the render surface. Also, a stroking style may be applied to a path when selecting a path in a selection use case.

According to disclosed embodiments, a stroke state specifies the following heuristics: (1) stroking space (e.g., object, paper, or canvas); (2) start and end sub-path style; and (3) joint style (e.g., none, bevel or miter).

According to disclosed embodiments, the stroke parameters define the following:

(1) stroke width: width of a stroke

(2) color: color of a stroke (e.g., red, blue, and green)

(3) pattern scale: scaling factor applied to a path to modify a dash pattern, thereby allowing to increase or decrease the number of patterns applied to a path.

According to disclosed embodiments, a dash pattern is applied to a path during stroking if the stroke state enables dashing. The dash pattern is a sequence of length intervals defining dashes and gaps in a path.

According to disclosed embodiments, a selection command, when enabled, computes if a selected region on a canvas space intersects a tested path. The paths successfully tested can be stored in a memory.

FIG. 5 is a flowchart of a process according to various disclosed embodiments. Such a process can be performed, for example, by any apparatus configured to perform a process as described. In one embodiment, at least a part of the process is performed by a graphics processing unit. In some embodiments, a graphics rendering system performs the process. In block 504, one or more paths are defined by a plurality of commands. In block 508, geometric transformations are applied to transform the paths from an object space to a render surface. In block 512, the paths are bound to an input stage. In block 516, the paths are stroked based on a stroke style.

Various disclosed embodiments are directed to methods of rendering graphics. According to disclosed embodiments, a method of rendering graphics includes defining one or more paths from a plurality of commands. The commands include corresponding coordinates and pen actions, and the commands generate sub-paths or curve segments.

The method includes applying geometric transformations to map the paths from an object space to a render surface. The method includes binding the paths to a path input stage, and stroking the paths bound to the path input stage based on a stroke style. The stroke style includes stroke parameters, stroke state and dash patterns. The stroke parameters include stroke width, color, and pattern scale.

According to disclosed embodiments, a non-transitory computer-readable medium is encoded with computer-executable instructions for rendering two-dimensional graphics. The computer-executable instructions when executed cause at least one data processing system to: define one or more paths from a plurality of commands; apply geometric transformations to map the paths from the object space to a render surface; bind the paths to a path input stage; and stroke the paths bound to the path input stage based on stroke style.

According to disclosed embodiments, a graphics rendering system for rendering two-dimensional graphics includes a graphics processing unit and a memory coupled to the graphics processing unit. The memory contains computer-executable instructions to cause the graphics processor unit to: define one or more paths from a plurality of commands; apply geometric transformations to map the paths from the object space to a render surface; bind the paths to a path input stage; and stroke the paths bound to the path input stage based on stroke style.

Those skilled in the art will recognize that, for simplicity and clarity, the full structure and operation of all systems suitable for use with the present disclosure is not being depicted or described herein. Instead, only so much of a system as is unique to the present disclosure or necessary for an understanding of the present disclosure is depicted and described. The remainder of the construction and operation of the disclosed systems may conform to any of the various current implementations and practices known in the art.

Of course, those of skill in the art will recognize that, unless specifically indicated or required by the sequence of operations, certain steps in the processes described above may be omitted, performed concurrently or sequentially, or performed in a different order. Further, no component, element, or process should be considered essential to any specific claimed embodiment, and each of the components, elements, or processes can be combined in still other embodiments.

It is important to note that while the disclosure includes a description in the context of a fully functional system, those skilled in the art will appreciate that at least portions of the mechanism of the present disclosure are capable of being distributed in the form of instructions contained within a non-transitory machine-usable, computer-usable, or computer-readable medium in any of a variety of forms. The present disclosure also applies equally regardless of the particular type of instruction or signal bearing medium or storage medium utilized to actually carry out the distribution. Examples of machine usable/readable or computer usable/readable non-transitory mediums include: nonvolatile, hard-coded type mediums such as read only memories (ROMs) or erasable, electrically programmable read only memories (EEPROMs), and user-recordable type mediums such as floppy disks, hard disk drives and compact disk read only memories (CD-ROMs) or digital versatile disks (DVDs).

Those skilled in the art to which this application relates will appreciate that other and further additions, deletions, substitutions and modifications may be made to the described embodiments.

What is claimed is:

1. A method of rendering graphics comprising:
defining one or more paths from a plurality of commands;
applying geometric transformations to map the paths from an object space to a render surface;
binding the paths to a path input stage; and
stroking the paths bound to the path input stage based on a stroke style.

2. The method of claim 1, wherein the commands include corresponding coordinates and pen actions, and wherein the commands generate sub-paths.

3. The method of claim 1, wherein the stroke style includes stroke parameters, stroke state and dash patterns.

4. The method of claim 3, wherein the stroke parameters include stroke width, color, and pattern scale.

5. The method of claim 3, wherein the stroke state includes stroke space, start and end sub-path cap styles and joint styles.

6. The method of claim 5, wherein the stroke space defines the object on which the stroke width and color are illustrated.

7. The method of claim 3, wherein the dash pattern includes lengths and gaps.

8. A non-transitory computer-readable medium encoded with computer-executable instructions for rendering two-dimensional graphics, wherein the computer-executable instructions when executed cause at least one data processing system to:
define one or more paths from a plurality of commands;
apply geometric transformations to map the paths from the object space to a render surface;
bind the paths to a path input stage; and
stroke the paths bound to the path input stage based on stroke style.

9. The non-transitory computer-readable medium of claim 8, wherein the commands include corresponding coordinates and pen actions, and wherein the commands generate sub-paths.

10. The non-transitory computer-readable medium of claim 8, wherein the stroke style includes stroke parameters, stroke state and dash patterns.

11. The non-transitory computer-readable medium of claim 8, wherein the stroke parameters include stroke width, color, and pattern scale.

12. The non-transitory computer-readable medium of claim 8, wherein the stroke state includes stroke space, start and end sub-path cap styles and joint styles.

13. A graphics rendering system for rendering two-dimensional graphics, comprising:
a graphics processing unit; and
a memory coupled to the graphics processing unit, wherein the memory contains computer-executable instructions to cause the graphics processing unit to
define one or more paths from a plurality of commands;
apply geometric transformations to map the paths from the object space to a render surface;
bind the paths to a path input stage; and
stroke the paths bound to the path input stage based on stroke style.

14. The graphics rendering system of claim 13, wherein the commands include corresponding coordinates and pen actions.

15. The graphics rendering system of claim 13, wherein the commands generate sub-paths.

16. The graphics rendering system of claim 13, wherein the stroke style includes stroke parameters, stroke state and dash patterns.

17. The graphics rendering system of claim 13, wherein the stroke parameters include stroke width, color, and pattern scale.

18. The graphics rendering system of claim 13, wherein the stroke state includes stroke space, start and end sub-path cap styles and joint styles.

19. The graphics rendering system of claim 18, wherein the stroke space defines the object on which the stroke width and color are illustrated.

20. The graphics rendering system of claim 16, wherein the dash pattern includes lengths and gaps.
